(19) United States
(12) Patent Application Publication
(10) Pub. No.: US 2025/0146626 A1
(43) Pub. Date: May 8, 2025

(54) PIPE SECTION, PIPE ASSEMBLY, METHOD FOR MANUFACTURING A PIPE SECTION, AND USE OF A PIPE ASSEMBLY

(71) Applicant: SMS GROUP GMBH, Mönchengladbach (DE)

(72) Inventors: Jorg Doege, Siegen (DE); Frank Lichtenthaler, Hachenburg (DE); Lars Moller, Herdorf (DE); Ulli Oberste-Lehn, Koln (DE); Michael STARK, Markdorf (DE); Jochen VOCHSEN, Erkelenz (DE)

(21) Appl. No.: 18/837,310

(22) PCT Filed: Feb. 9, 2023
(86) PCT No.: PCT/EP2023/053208

§ 371 Date: Aug. 9, 2024

(30) Foreign Application Priority Data
Feb. 11, 2022 (DE) 10 2022 103 244.2

(51) Int. Cl. F17D 1/08; B23K 26/34; B23K 101/06; C23C 4/131; F16L 9/02; F17D 1/04

(52) U.S. Cl. CPC F17D 1/08; B23K 26/34; C23C 4/131; F16L 9/02; F17D 1/04; B23K 2101/06

(57) ABSTRACT

A pipe section includes a support layer consisting of a metal base material. The support layer has an inner surface, at least two pipe section ends each having an end region, and an intermediate region. Each end region of the inner surface of the support layer has a first coating consisting of a first metal coating material. The first coating is welded to the support layer. The intermediate region of the inner surface of the support layer has a second coating consisting of a second metal coating material. The second coating is sprayed onto the support layer using a thermal spraying process and has a second thickness. The second thickness is less than or equal to 2500 μm.

The invention relates to a pipe section, a pipe assembly, a method for manufacturing a pipe section and a pipe assembly, and a use of a pipe assembly.

This patent application claims the priority of the German patent application no. 10 2022 103 244.2, the disclosure content of which is hereby expressly incorporated by reference.

Corrosion-resistant media-carrying conduit pipes and/or media-carrying line pipes lined against abrasive wear are known in various embodiments in the prior art and are used in particular as water, gas or oil pipeline pipes and/or in the chemical industry.

In the oil and gas extraction industry in particular, the demand for corrosion-resistant pipes is growing, as the fluids to be extracted are expected to have higher water content and higher concentrations of hydrogen sulphide (H₂S) and carbon dioxide (CO₂) in the future.

There is also an emerging trend that the fluids to be extracted are increasingly carrying hard solids, which means that special protection of the pipes against abrasive wear is increasingly in the interest of pipeline operators.

Suitable pipes for such media are steel pipes with a suitable inner coating, an inner lining or an inner cladding or a separate inner pipe, which offer cost advantages over pipes made of high-alloy steels.

For example, steel pipes are known which have a plastic wear protection layer on the media-conveying inner side to protect against corrosion and/or abrasive wear. This is also referred to as organic corrosion protection, wherein liquid applied epoxy layers or multi-layer plastic wear protection layers are known. In the latter case, epoxy resin mixtures are usually applied in powder form to the inner surface of a heated pipe. Although such organic coatings are relatively corrosion-resistant, their service life is limited when used for media containing hard solid particles, since the plastic wear protection layer is worn away comparatively quickly by abrasive wear.

Furthermore, clad steel pipes are known which are provided with an inner cladding made of a corrosion-resistant and/or abrasion-resistant metal material.

According to their different manufacturing processes, internally clad steel pipes can be divided into metallurgically clad steel pipes and hydromechanically clad steel pipes.

Metallurgically clad pipe sections are usually formed from a roll-clad or explosive-clad precursor material and welded to form a pipe section. The two metal layers are metallurgically firmly bonded together by a diffusion bridge, which is why they are also referred to as metallurgically clad pipe sections. When selecting materials for metallurgically clad pipe sections, it must be taken into account that the different materials must be sufficiently metallurgically compatible with one another for a sufficiently strong diffusion bridge.

Hydromechanically clad pipe sections are a well-known alternative to metallurgically clad pipe sections. These are manufactured by means of a hydraulic expansion process of an inner pipe in a seamless or welded outer pipe. This method is also known as hydroforming. Here, the inner pipe is inserted into a suitable outer pipe and first elastically, then plastically deformed until it rests against the inner wall of the outer pipe. This is followed by a joint expansion of the inner and outer pipes by about 0.5% to 1%, wherein the outer pipe is held by an outer tool. In this way, the inner pipe is placed in a state of residual compressive stress due to the usually larger elastic springback rate of the outer pipe, so that the inner pipe is compressed into the outer pipe. The material thicknesses can be tailored to the requirements for strength and corrosion protection. With regard to the material combination, however, it must be taken into account that the inner pipe and the outer pipe must be closed at the end faces by a common welded connection before expansion in order to prevent moisture from penetrating into the space between the pipes during the expansion process. After expansion, the inner pipe and the outer pipe are chamfered at the end faces and again provided with a seal weld welding or weld cladding so that no moisture can penetrate between the inner pipe and the outer pipe in the finished pipe section. A final chamfer can then be applied to the hydromechanically clad pipe section and the ends of the pipe sections can be calibrated using mechanical tools to ensure that the required tolerances are met.

According to a further development known in the prior art, hydromechanically clad pipe sections can be provided with an adhesive between the inner pipe and the outer pipe.

In addition to a plastic wear protection layer and the internally clad steel pipes, an inner coating with corrosion-resistant and/or more abrasion-resistant weldable metals can be bonded to the outer pipe by a deposition weld. This procedure is time-consuming, heat input into the outer pipe cannot be avoided and the materials of the outer pipe and the welding filler material are mixed.

The inner coating is applied in a plurality of so-called weld beads arranged next to one another, which also makes the surface structure comparatively rough and uneven. To avoid high flow resistance, machining reworking can be carried out.

The object of the invention is that of providing an improvement over or an alternative to the prior art.

According to a first aspect of the invention, the object is achieved by a pipe section, in particular a pipe section for conveying oil and/or gas, comprising:
a support layer consisting of a metal base material, wherein the support layer has a length, an inner diameter, an inner surface, an outer surface, at least two pipe section ends each having an end region and an intermediate region;
in each end region of the inner surface of the support layer, a first coating consisting of a first metal coating material, wherein the first coating is welded to the support layer, wherein the first coating has a first thickness, a penetration depth and a longitudinal extension; and
in the intermediate region of the inner surface of the support layer, a second coating consisting of a second metal coating material, wherein the second coating is sprayed onto the support layer using a thermal spraying process;
   wherein the second coating has a second thickness of less than or equal to 2500 μm, preferably a second thickness of less than or equal to 750 μm, and more preferably a second thickness of less than or equal to 500 μm.

In this regard, the following is explained conceptually:

It is first expressly noted that in the context of the present patent application, indefinite articles and numbers such as “one,” “two,” etc. should generally be understood as being “at least” statements, i.e. as “at least one.,” “at least two . . . ,” etc., unless it is clear from the relevant context or it is obvious or technically compelling to a person skilled in the art that only “exactly one . . . ,” “exactly two . . . ,” etc. can be meant.

In the context of the present patent application, the expression “in particular” should always be understood as introducing an optional, preferred feature. The expression should not be understood to mean “specifically” or “namely.”

A “pipe section” is understood to be an elongated hollow body which is designed for transporting a designated fluid.

A pipe section can be designed to transport a designated fluid in the event of corrosive-chemical stress caused by the fluid and/or abrasive wear caused by entrained granulated solids.

In particular, a pipe section can be designed for transporting oil and/or gas and/or a fluid containing a liquid fossil energy carrier and/or for use in chemical plant construction.

A “support layer” is understood to mean a layer of the pipe section made of a base material which is designed to absorb and transmit external and/or internal loads.

Compared to the first coating and/or second coating, the support layer can be a thick-walled hollow body. The support layer can be adjacent to the first coating and/or second coating on the outside.

The support layer can have a weld seam or be manufactured seamlessly.

The support layer can have an inner diameter of greater than or equal to 150 mm, preferably an inner diameter of greater than or equal to 250 mm, preferably an inner diameter of greater than or equal to 450 mm, and more preferably an inner diameter of greater than or equal to 650 mm. Further preferably, the inner diameter of the support layer is greater than or equal to 850 mm, preferably greater than or equal to 1050 mm, and more preferably greater than or equal to 1250 mm.

The support layer can have a wall thickness of greater than or equal to 6 mm, preferably a wall thickness of greater than or equal to 8 mm, preferably a wall thickness of greater than or equal to 10 mm, and more preferably a wall thickness of greater than or equal to 12 mm. In addition, the support layer can have a wall thickness of greater than or equal to 15 mm, preferably a wall thickness of greater than or equal to 20 mm, preferably a wall thickness of greater than or equal to 25 mm, and more preferably a wall thickness of greater than or equal to 30 mm. Further preferably, the support layer can have a wall thickness of greater than or equal to 35 mm, preferably a wall thickness of greater than or equal to 40 mm, preferably a wall thickness of greater than or equal to 45 mm, and more preferably a wall thickness of greater than or equal to 50 mm.

The support layer can have a length of greater than or equal to 4 m, preferably a length of greater than or equal to 8 m, preferably a length of greater than or equal to 12 m, and more preferably a length of greater than or equal to 13 m.

The support layer can be essentially circular in shape, wherein it can exhibit ovality.

A “base material” of the support layer is defined as a steel as an iron-carbon alloy with a maximum carbon mass fraction of 2.1%. In addition to its main component iron, the base material preferably contains mainly carbon as a secondary component. In other words, the component of an alloy component or the component of the sum of the alloy components can be smaller than the carbon content of the base material.

The base material can have a carbon content of less than or equal to 0.3%, preferably a carbon content of less than or equal to 0.26%, and more preferably a carbon content of less than or equal to 0.22%, which can improve the weldability of the base material.

The base material can contain manganese, which can improve the forgeability, weldability, strength and wear resistance of the base material. Preferably, the base material has a manganese content of greater than or equal to 0.8%, preferably a manganese content of greater than or equal to 1.2%, preferably a manganese content of greater than or equal to 1.4%, and more preferably a manganese content of greater than or equal to 1.6%.

A silicon content in the base material can increase the tensile strength and yield strength. The base material can have a silicon content of greater than or equal to 0.35%, preferably a silicon content of greater than or equal to 0.4%, and more preferably a silicon content of greater than or equal to 0.45%.

The yield strength of the base material can be greater than or equal to 280 N/mm², preferably greater than or equal to 350 N/mm², preferably greater than or equal to 350 N/mm², and more preferably greater than or equal to 410 N/mm². Further preferably, the yield strength of the base material is greater than or equal to 440 N/mm², preferably greater than or equal to 480 N/mm², and more preferably greater than or equal to 550 N/mm².

The base material can be a material according to the API standard (American Petroleum Institute), in particular an X42, an X52, an X60, an X65, an X70, an X80 or a base material having a higher content of alloying elements. Furthermore, the metal base material can be an L 360QB, an L 415QB, an L 450QB or an L 485QB according to DIN EN 10208-2.

A pipe section has a “pipe section end” at each end of the elongated hollow body, which is adjoined by an “end region”. The end regions arranged on both sides extend with a “longitudinal extension” to the essentially central or centrally arranged “intermediate region” of the pipe section.

The end regions are determined by the “first coatings” made of a “first coating material” arranged on the inner surface of the support layer in the end regions on both sides.

The intermediate region has a “second coating” made of a “second coating material”.

The length of the intermediate region is at least greater than or equal to the length of the support layer minus the respective longitudinal extensions of the end regions, so that a continuous coating can be ensured. For this purpose, the second coating and the first coating can be arranged at least partially overlapping in an overlap region, wherein the second coating overlaps the first coating.

The first and second coating materials can be identical, so that the material properties of the coating in a pipe assembly comprising a plurality of pipe sections can be largely homogeneous over the course of the pipe assembly, in particular with respect to a designated fluid in the pipe assembly. However, the first and second coating materials can also differ from one another, so that a desired alloy is formed, in particular in the region of a materially-bonded connection, which in turn has the necessary corrosion resistance and/or abrasion-resistant properties.

In particular, the first coating and/or the second coating has sufficient corrosion resistance to H₂S and/or CO₂, which is currently not achieved by a plastic coating.

The first coating is “welded” to the support layer, which is understood to mean a material-bonded connection between the support layer and the first coating created by a deposition welding process. This results in a “penetration depth”, which is characterized by a material dilution of the base material of the support layer and the first coating material and is limited to the region that was occupied by the base material of the support layer before welding.

The “first thickness” of the first coating is understood to mean the thickness of the first coating layer extending radially to the longitudinal extension direction of the pipe section. The first thickness therefore also comprises the penetration depth of the first coating.

The “second thickness” of the second coating is understood to mean the thickness of the second coating layer extending radially to the longitudinal extension direction of the pipe section. The second thickness is evaluated based on the average roughness of the inner surface of the support layer.

The second thickness of the second coating may be smaller than the first thickness of the first coating.

A “thermal spraying process” is understood to mean a surface coating process, wherein a spray material is liquefied inside or outside a spray burner, accelerated in a gas stream in the form of spray particles and thrown onto the surface of the component to be coated. The advantage of this is that the component surface is not melted and is only subjected to a low thermal load. A layer formation takes place because the spray particles flatten to a greater or lesser extent when they hit the component surface, depending on the process and material, adhere primarily through mechanical clamping and, layer by layer, build up the spray layer. Quality characteristics of spray coatings are low porosity, good bonding to the component, freedom from cracks and homogeneous microstructure. Thermal spraying processes can be differentiated based on the energy carrier used to liquefy the spray material. The different processes include arc spraying, plasma spraying, flame spraying, cold gas spraying and laser spraying.

By using a first coating bonded to the support layer by a materially bonded connection and a second coating bonded to the support layer by a form fit, it can be advantageously achieved that the coating is robust against the heat input during the designated welding of a plurality of pipe sections to form a pipe assembly and any mechanical loads occurring at the ends of the pipe sections, while at the same time being cost-effective.

The second coating may have a second thickness of less than or equal to 1500 μm, preferably a second thickness of less than or equal to 1000 μm, further preferably a second thickness of less than or equal to 600 μm, and more preferably a second thickness of less than or equal to 400 μm. Furthermore, the second coating may have a second thickness of less than or equal to 300 μm, preferably a second thickness of less than or equal to 200 μm, further preferably a second thickness of less than or equal to 150 μm, and more preferably a second thickness of less than or equal to 100 μm.

The first coating and the second coating interact to prevent corrosion and/or abrasive wear of the support layer.

Surprisingly, and contrary to the previous assumption that higher second thicknesses lead to a lower delamination tendency of the second coating, it was found that this is reversed with further increase in the second thickness. The second coating exhibits a slight porosity due to the thermal spraying process with which it is applied. It has been shown that, in conjunction with a corrosion process within the pores, a greater layer thickness of the second coating can lead to a reduced delamination resistance of the second coating.

TABLE 1
Second thickness, material cost, resistance to abrasive
wear and delamination resistance (each rated between 0
and 10, wherein 0 is the smallest possible value and 10
is the greatest possible value of the respective property.)

| Second | | Resistance to | Delamination |
|---|---|---|---|
| thickness | Material costs | abrasive wear | resistance |
| 100 μm | 0.4 | 0.2 | 7 |
| 150 μm | 0.6 | 0.5 | 9 |
| 200 μm | 0.8 | 0.8 | 10 |
| 300 μm | 1.2 | 1.2 | 10 |
| 400 μm | 1.6 | 1.6 | 10 |
| 500 μm | 2 | 2 | 10 |
| 600 μm | 2.4 | 2.4 | 9 |
| 750 μm | 3 | 3 | 9 |
| 1000 μm | 4 | 4 | 8 |
| 1500 μm | 6 | 6 | 7 |
| 2500 μm | 8 | 8 | 4 |
| 3000 μm | 10 | 10 | 2 |

Therefore, a second thickness of the second coating with a specified maximum thickness is proposed here.

At the same time, this significantly reduces the amount of effort required to achieve a long-term durable and corrosion-resistant coating on a pipe section. This is because no complex cladding of the entire pipe section region is required and no subsequent coating is required in the weld seam region on the inner surface after the individual pipe sections have been welded.

Due to its first and second coating, the pipe section proposed here is particularly robust against corrosion and/or abrasion, in particular in comparison to currently known plastic coatings.

The comparatively low material thickness of the second coating can have the advantage that the use of cost-intensive alloying elements can be reduced.

Compared to the outer pipe of a hydromechanically clad pipe section, the roughness on the inner surface of the support layer can be greater, which allows a better material bond between the support layer and the coating to be achieved.

Compared to metallurgically clad pipe sections, the material combination of the base material of the support layer and the first and/or second coating material is not dependent on the diffusion bond to be induced during metallurgical cladding.

Compared to a hydromechanically clad pipe section, the second coating material can be selected independently of its weldability with the base material. In hydromechanical cladding, the need for a seal welded connection between the support layer and the coating means that the entire coating material must be weldable in combination with the base material.

By allowing a largely free choice of the second coating material, a better resistance to abrasion and/or a better corrosion resistance and/or a higher ductility of the second coating can be achieved.

Compared to a hydromechanically clad pipe section, no plastic deformation of the support layer occurs when the first and/or second coating is applied, which can reduce or prevent the effort required for calibration of the pipe section ends.

In particular, the use of a comparatively thin coating compared to the hydromechanically clad pipe section, the inner pipe of which has a thickness of greater than or equal to 3 mm due to the process, leads to a lower requirement for particularly cost-intensive alloying elements and thus to an economic superiority compared to a hydromechanically clad pipe section, which in turn already has these compared to a metallurgically clad pipe section due to the precursor material used and the manufacturing process.

In summary, the pipe section proposed here can be optimized to meet the highest requirements for strength and/or corrosion resistance and/or resistance to abrasive wear and/or cost-effectiveness. The support layer consisting of the base material meets the static and/or dynamic mechanical requirements and the first and second coatings counteract corrosion and/or abrasive wear.

According to a more preferred embodiment, the second coating has a second thickness of greater than or equal to 100 μm, preferably a second thickness of greater than or equal to 200 μm, and more preferably a second thickness of greater than or equal to 400 μm.

The second coating may have a second thickness of greater than or equal to 150 μm, preferably a second thickness of greater than or equal to 300 μm, further preferably a second thickness of greater than or equal to 500 μm, and more preferably a second thickness of greater than or equal to 600 μm. Furthermore, the second coating may have a second thickness of greater than or equal to 750 μm, preferably a second thickness of greater than or equal to 1000 μm, further preferably a second thickness of greater than or equal to 1500 μm, and more preferably a second thickness of greater than or equal to 2500 μm.

With the minimum values required here for the second thickness, it is possible to achieve sufficient resistance to corrosion and abrasive wear as well as sufficient delamination resistance of the second coating.

Particularly expediently, the support layer, on the inner surface, has a roughness Ra of greater than or equal to 4.1 μm, preferably a roughness Ra of greater than or equal to 5.0 μm, and more preferably a roughness Ra of greater than or equal to 6.3 μm.

In this regard, the following is explained conceptually:

A “roughness” refers to the unevenness of the surface height. There are different calculation methods for the quantitative characterization of roughness, each of which takes into account different characteristics of the surface. The “roughness Ra” or mean roughness indicates the average distance of a measuring point on the surface from the center line.

Furthermore, the support layer, on the inner surface, may have a roughness Ra of greater than or equal to 3.2 μm, preferably a roughness Ra of greater than or equal to 5.6 μm, preferably a roughness Ra of greater than or equal to 7.1 μm, and more preferably a roughness Ra of greater than or equal to 8.0 μm.

By using a thermal spraying process to apply the second coating, the support layer and the second coating are connected together by a form fit. It has been shown that with the roughness values required here, a particularly good adhesion of the second coating to the support layer can be achieved.

The required minimum values for roughness can be achieved in particular by means of a surface preparation process, in particular by means of a blasting process, in particular using corundum.

Thus, a roughness of the support layer on the inner surface is required here, which is comparatively high compared to a rolled surface with a characteristic roughness Ra of less than or equal to 0.1 μm, as a result of which a better form fit and/or a better adhesion of the coating, in particular the second coating, to the support layer can be achieved.

Expediently, the support layer, on the inner surface, has a roughness Ra of less than or equal to 12.5 μm, preferably a roughness Ra of less than or equal to 10.0 μm, and more preferably a roughness Ra of less than or equal to 8.0 μm.

Furthermore, the support layer, on the inner surface, may have a roughness Ra of less than or equal to 5.0 μm, preferably a roughness Ra of less than or equal to 5.6 μm, preferably a roughness R a of less than or equal to 6.3 μm, and more preferably a roughness Ra of less than or equal to 7.1 μm.

It has been found that with increasing values of the roughness of the inner surface of the support layer, a greater second thickness of the second coating may be necessary in some embodiments in order to achieve homogeneous and sufficiently durable properties of the second coating.

Due to the maximum values required here for the roughness Ra on the inner surface of the support layer, for some application cases, the second thickness of the second coating can be brought into a good compromise between adhesion of the second coating to the support layer and costs for the second coating.

According to a further expedient embodiment, the support layer has a shoulder on an inner edge.

Particularly preferably, the longitudinal extension of the shoulder can correspond to the longitudinal extension of the first coating.

A shoulder can be used to ensure that the support layer no longer exhibits any ovality in the region of the shoulder on the inner surface, which can facilitate designated connecting of a plurality of pipe sections to form a pipe assembly.

In some embodiments, it has proven advantageous for the thickness of the first coating to be greater than the thickness of the second coating. The shoulder proposed here makes it possible to achieve a largely straight course of the inner surface of the pipe section in the region of the transition from the first coating to the second coating, despite different coating thicknesses. This allows the designed flow resistance of the pipe section to be advantageously reduced.

Preferably, the support layer and/or the first coating has a chamfer on an inner edge and/or an outer edge.

This can be used to support the welding of a plurality of pipe sections to form a pipe assembly. In particular, homogeneous connecting weld seam outer surfaces can be achieved with less or no weld reinforcement, in particular for the first coating. In this way, the properties of the first coating can be retained even after welding to form a pipe assembly and an advantageously low flow resistance can be achieved in the region of the previous pipe section ends.

Preferably, the first coating is applied to the support layer using a deposition welding process, in particular using a laser deposition welding process.

In this regard, the following is explained conceptually:

The term “deposition welding” refers to welding in which volume build-up, usually in the form of a covering layer, takes place exclusively through the welding filler material. It is therefore considered coating.

One possible deposition welding process for the first coating can be a conventional deposition welding process, in particular a classic wire fusion welding process, with which advantageously high layer thicknesses can be achieved.

In “laser deposition welding”, a high-power laser serves as the heat source. This has the advantage of achieving a low penetration depth compared to other deposition welding processes.

Particularly preferably, the first coating has a penetration depth of less than or equal to 500 μm, preferably a penetration depth of less than or equal to 150 μm, and more preferably a penetration depth of less than or equal to 75 μm.

Furthermore, the first coating may have a penetration depth of less than or equal to 250 μm, preferably a penetration depth of less than or equal to 100 μm, preferably a penetration depth of less than or equal to 40 μm, and more preferably a penetration depth of less than or equal to 25 μm.

While the material properties are retained in the base material, the material properties in the heat-affected zone required by the deposition welding process change due to grain growth, phase transformations, precipitation processes at the grain boundaries or even hardening of the physical material properties, as well as in the weld metal due to crystallization (formation of a cast structure), dissolution phenomena of accompanying elements, precipitation processes, segregation, shrinkage and residual stresses that arise. The smaller the penetration depth, the smaller the heat-affected zone and thus the smaller the energy input into the base material of the support layer.

The welding filler material applied for the first coating also receives a more homogeneous microstructure composition with a low iron content due to the lower dilution with iron at a smaller penetration depth, and the properties of the welding filler material are largely retained even after deposition welding.

In this respect, a penetration depth that is as small as possible is advantageous.

Expediently, the first coating has a first thickness of less than or equal to 2500 μm, preferably a first thickness of less than or equal to 1000 μm, and more preferably a first thickness of less than or equal to 600 μm.

Furthermore, the first coating may have a first thickness of less than or equal to 5000 μm, preferably a first thickness of less than or equal to 1500 μm, preferably a first thickness of less than or equal to 750 μm, and more preferably a first thickness of less than or equal to 550 μm.

The values required here for the first thickness of the first coating enable an advantageously thin first coating, which can reduce material costs for the first coating material and costs for applying the first coating.

Optionally, the first coating has a first thickness of greater than or equal to 500 μm, preferably a first thickness of greater than or equal to 600 μm, and more preferably a first thickness of greater than or equal to 700 μm.

Further optionally, the first coating has a first thickness of greater than or equal to 400 μm, preferably a first thickness of greater than or equal to 550 μm, and more preferably a first thickness of greater than or equal to 650 μm.

When using a plurality of pipe sections for a pipe assembly, it is advantageous to connect these pipe sections to one another in a materially bonded manner by welding the corresponding pipe section ends together. The support layer and the first coating are made of different materials, which are mixed together at least in a transition layer as a result of the process. In particular on the inner surface of the first coating, it is advantageous for the properties of the first coating if the first coating consists only or at least predominantly of the first coating material. When welding a plurality of pipe sections to form a pipe assembly, further dilution of the base material and the first coating material can also occur, which can adversely affect the properties of the first coating.

The values required here for the first thickness of the first coating can enable only or at least predominantly the first coating material to be present on the inner surface of the first coating of a pipe section or pipe assembly.

According to an expedient embodiment, the first coating has a longitudinal extension of greater than or equal to 30 mm, preferably a longitudinal extension of greater than or equal to 50 mm, and more preferably a longitudinal extension of greater than or equal to 65 mm.

Expediently, the first coating may have a longitudinal extension of greater than or equal to 15 mm, preferably a longitudinal extension of greater than or equal to 20 mm, preferably a longitudinal extension of greater than or equal to 40 mm, and more preferably a longitudinal extension of greater than or equal to 60 mm. Further expediently, the first coating may have a longitudinal extension of greater than or equal to 70 mm, preferably a longitudinal extension of greater than or equal to 80 mm, preferably a longitudinal extension of greater than or equal to 90 mm, and more preferably a longitudinal extension of greater than or equal to 100 mm.

When connecting a plurality of pipe sections in a materially bonded manner to form a pipe assembly, heat input occurs at the respective pipe section ends and in the corresponding end regions. This can have a negative effect on the properties of the second coating. The values required here for the longitudinal extension of the first coating can reduce heat input into the second coating by welding a plurality of pipe sections together to such an extent that the properties of the second coating are no longer or at least no longer significantly influenced by this.

According to a preferred embodiment, the first coating has a first thickness varying with the circumferential angle of the pipe section.

Here, the first thickness can vary in particular with the circumferential angle in the pipe section. This allows any ovality of the support layer to be reduced by varying the thickness of the first coating.

This can simplify the manufacture of a pipe assembly according to the fourth aspect of the invention and/or reduce a flow resistance acting on a designated fluid flowing through the pipe assembly.

More preferably, the second coating is sprayed onto the support layer using an arc spraying process.

In this regard, the following is explained conceptually:

The term “arc spraying process” refers to a wire spraying process in which electrically conductive materials are sprayed to produce a coating. An arc is ignited between two wire-shaped spray materials of the same or different types. The wire tips are melted at a temperature of up to around 4000° C. and fanned onto the workpiece surface by means of an atomizing gas. The use of nitrogen or argon instead of air as atomizing gas can advantageously reduce oxidation of the materials.

By using the arc spraying process, the application rate of the second coating can be advantageously increased. Furthermore, it is possible to use any electrically conductive wire alloy advantageously as a coating material. It is particularly advantageous to achieve a very thin second thickness of the second coating of greater than or equal to 50 μm. According to tests carried out, the second coating, produced using an arc spraying process, is particularly robust and reliable.

By using the arc spraying process, a variable second thickness can be achieved so that an adaptation to local needs can be achieved. In particular, this can have an advantageous effect in the transition from the first coating to the second coating, so that a robust layer transition and/or the lowest possible flow resistance can be ensured, wherein the second coating applied using the arc spraying process at least partially overlaps the first coating. Furthermore, a variable layer thickness can contribute to reducing the internal ovality of the pipe section.

Advantageously, the arc spraying process can be used to apply a metal coating which has an advantageous hardness, abrasion resistance and cold impact resistance.

Preferably, the first coating and/or the second coating has a nickel content of greater than or equal to 38 wt. %, preferably a nickel content of greater than or equal to 48 wt. %, and more preferably a nickel content of greater than or equal to 58 wt. %, and/or a nickel content of less than or equal to 75 wt. %, preferably a nickel content of less than or equal to 70 wt. %, and more preferably a nickel content of less than or equal to 65 wt. %.

The nickel content can ensure that the first coating and/or the second coating have a high corrosion resistance and/or a high hardness and/or a high toughness and/or a high ductility.

A first coating material and/or second coating material may be, inter alia, Inconel Alloy 625 (also known as AISI Alloy 625, UNS N06625, NiCr22Mo9Nb and/or EN 2.4856), Inconel Alloy 825, Inconel Alloy 59, Inconel Alloy 926 and/or Inconel Alloy 367.

Inconel Alloy 625 is a nickel-based alloy characterized by high strength properties and resistance to high temperatures. It also offers remarkable protection against corrosion, even in highly acidic environments, and oxidation. Furthermore, the alloy exhibits a very good creep resistance and a very good weldability.

Specifically, the base material of the support layer can be a material according to the API standard (American Petroleum Institute), in particular an X42, an X52, an X60, an X65, an X70, an X80 or a base material with a higher content of alloying elements. Furthermore, the metal base material according to DIN EN 10208-2 can be an L 360QB, an L 415QB, an L 450QB or an L 485QB, wherein this base material is coated with a first coating and/or a second coating of Alloy 625. In other words, consider a substrate layer made of an X42 or a base material from the above list with a higher yield strength than X42, coated with a first coating and/or a second coating of Alloy 625.

Preferably, the first coating and/or the second coating has a chromium content of greater than or equal to 12 wt. %, preferably a chromium content of greater than or equal to 16 wt. %, and more preferably a chromium content of greater than or equal to 20 wt. %, and/or a chromium content of less than or equal to 31 wt. %, preferably a chromium content of less than or equal to 27 wt. %, and more preferably a chromium content of less than or equal to 23 wt. %.

Due to the chromium content, the first coating and/or the second coating can exhibit a particularly strong corrosion resistance and/or a particularly good heat resistance.

Further preferably, the first coating and/or the second coating has a molybdenum content of greater than or equal to 2 wt. %, preferably a molybdenum content of greater than or equal to 5 wt. %, and more preferably a molybdenum content of greater than or equal to 8 wt. %, and/or a molybdenum content of less than or equal to 17 wt. %, preferably a molybdenum content of less than or equal to 13 wt. %, and more preferably a molybdenum content of less than or equal to 10 wt. %.

The proposed molybdenum content can improve the acid resistance and thus the corrosion resistance of the first coating and/or the second coating. Furthermore, the molybdenum content proposed here can be used to increase the hardness and strength of the first coating and/or second coating and thus the resistance to abrasive wear. In addition, the molybdenum component can prevent or reduce temper embrittlement of the first coating and/or the second coating.

In other words, the molybdenum content can improve the strength, corrosion resistance and heat resistance of the first coating and/or the second coating.

Optionally, the first coating and/or the second coating has a content of niobium in combination with tantalum of greater than or equal to 2 wt. %, preferably a content of niobium in combination with tantalum of greater than or equal to 2.6 wt. %, and more preferably a content of niobium in combination with tantalum of greater than or equal to 3.15 wt. %, and/or a content of niobium in combination with tantalum of less than or equal to 6 wt. %, preferably a content of niobium in combination with tantalum of less than or equal to 5 wt. %, and more preferably a content of niobium in combination with tantalum of less than or equal to 4.15 wt. %.

Advantageously, the weldability of the first coating and/or second coating can be improved by the content of niobium. Due to the similarity of niobium and tantalum, niobium ores predominantly also contain tantalum, which is why it is advantageous not to separate the tantalum from the niobium and to add a combination of niobium and tantalum as alloying elements to the first coating and/or the second coating.

More preferably, the first coating and/or the second coating has a Vickers hardness, measured at 20° C., of greater than or equal to 150 HV, preferably a Vickers hardness of greater than or equal to 200 HV, and more preferably a Vickers hardness of greater than or equal to 250 HV.

The term “hardness” refers to the mechanical resistance that the first coating and/or the second coating offer to the mechanical penetration of another body. The Vickers hardness corresponds to the hardness according to the hardness test named after the company Vickers, which is particularly suitable for thin-walled coatings due to the flat shape of the test specimen.

By selecting a coating material with a hardness greater than or equal to the value required here, in particular the resistance to abrasive wear can be increased.

Furthermore, it is more preferred that the first coating and/or the second coating has an elongation at break A, measured at 20° C., of greater than or equal to 25%, preferably an elongation at break A of greater than or equal to 30%, and more preferably an elongation at break A of greater than or equal to 35%.

In this regard, the following is explained conceptually:

The “elongation at break A” is a characteristic value in materials science that indicates the permanent elongation of the tensile specimen after break, relative to the initial gauge length, after uniaxial mechanical loading. The higher the value of the elongation at break of a material, the higher the ductility or deformability of the material

If the yield strength of a material is exceeded, irreversible changes occur in its crystal lattice. If the load on the material is removed, the component returns to its original position, wherein a “plastic strain” remains.

Ductile materials have the advantage that plastic strains up to a certain limit do not lead to brittle fracture of the workpiece made from the material. However, if plastic strains occur during the life cycle of the workpiece, in this case the pipe section, it should be ensured that the workpiece is not plastically strained to such an extent that the functionality of the workpiece can no longer be guaranteed.

In some application cases of the pipe sections proposed here, said pipe sections are first connected to one another to form a pipe assembly, which is then wound up for transport and unwound again after transport. This winding process requires that the materials used for the support layer, the first coating and the second coating can be plastically deformed with the support layer without causing any damage. In other words, the support layer, the first coating and the second coating require sufficient ductility to prevent brittle fractures and/or to prevent or at least sufficiently reduce delamination of the coating at locally plastically deformed regions.

For the second coating material in particular, it has been shown under application conditions that the ductility required here can counteract any delamination of the second coating material, even if the pipe section as a whole is not plastically deformed.

According to an expedient embodiment, the first coating and/or the second coating has a yield strength R_{p0.2}, measured at 20° C., of greater than or equal to 280 N/mm², preferably a yield strength R_{p0.2} of greater than or equal to 300 N/mm², and more preferably a yield strength R_{p0.2} of greater than or equal to 320 N/mm².

In this regard, the following is explained conceptually:

The “yield strength R_{p0.2}” is understood to be the uniaxial mechanical stress at which the residual plastic strain after unloading, based on the initial length of the specimen, is 0.2%. The yield strength R_{p0.2} is therefore a strength parameter for a material, in particular the first coating and/or the second coating.

Due to the values of the yield strength R_{p0.2} required here, the first coating and/or the second coating can be adapted particularly advantageously to the material behavior of the support layer.

If elastic and/or plastic deformation of the support layer occurs, this deformation also affects the first and/or second coating. If the yield strength R_{p0.2} of the support layer and the first coating and/or second coating are too different, i.e. in particular if the values for the yield strength R_{p0.2} are too small and if the values for the yield strength R_{p0.2} for the first and/or second coating material are too large, this can lead to residual stresses in the support layer and/or the first coating and/or the second coating, which can cause delamination of the second coating.

If the yield strength R_{p0.2} for the first and/or second coating material is lower than the yield strength of the support layer, it may happen that the support layer deforms in the purely elastic region, while the first coating and/or the second coating are already experiencing plastic strain. If there is no external load on the pipe section, residual stresses can occur, in particular in a contact layer between the support layer and the first coating and/or second coating.

If the yield strength R_{p0.2} for the first and/or second coating material is higher than the yield strength of the support layer, it may happen that the support layer deforms plastically, while the first coating and/or the second coating experience a purely elastic deformation, which may also cause residual stresses to occur in a contact layer between the support layer and the first coating and/or the second coating.

By using the values for the yield strength R_{p0.2} required here, the occurrence of residual stresses in a contact layer between the support layer and the first coating and/or the second coating as a result of deformation of the pipe section can be prevented or at least reduced.

Expediently, the first coating and/or the second coating has a tensile strength Rₘ, measured at 20° C., of greater than or equal to 650 N/mm², preferably a tensile strength Rₘ of greater than or equal to 685 N/mm², and more preferably a tensile strength Rₘ of greater than or equal to 720 N/mm².

In this regard, the following is explained conceptually:

The “tensile strength Rₘ” is understood to be the maximum uniaxial mechanical stress that the material can withstand until failure.

By using the values required here for the tensile strength Rₘ of the first and/or second coating material, the formation of cracks in the first coating and/or second coating under normal use conditions and/or during winding and/or unwinding of a pipe assembly can be prevented or at least greatly reduced.

According to a preferred embodiment, the first coating and/or the second coating has a sealing.

In this regard, the following is explained conceptually:

Coatings, in particular coatings produced using a thermal spray process, can exhibit porosity. As a result, a coating may have openings on the surface of the coating that communicate with capillary spaces within the coating, allowing a designated fluid within the pipe section to penetrate into capillary spaces within the coating, which may adversely affect corrosion and/or abrasive wear. The term “sealing” is understood to mean the at least partial filling of openings in the surface of the first coating and/or the second coating as well as of communicating capillary spaces.

By means of the sealing proposed here, openings and capillary spaces communicating with them in the surface of the first coating and/or the second coating can advantageously be at least partially filled, so that after sealing, penetration of a designated fluid in the pipe section into the capillary space can be prevented or at least reduced. In this way, the corrosion protection of the first coating and/or the second coating can be improved.

Optionally, the sealing is polymer-based.

A “polymer-based sealing” is understood to mean a sealing with a material that consists of macromolecules.

In this way, a seal can be achieved with an advantageously low viscosity of the sealing material at the time of processing and with an advantageously high viscosity after processing, so that the sealing material can, on the one hand, advantageously penetrate into small openings and capillary spaces and, on the other hand, can be cured after penetration to form a particularly hard and robust structure.

According to a second aspect of the invention, the object is achieved by a pipe assembly comprising at least two pipe sections according to the first aspect of the invention, wherein a first pipe section and a second pipe section are connected to one another in a materially bonded manner at two corresponding pipe section ends.

A widespread use of one or more pipe sections according to the first aspect of the invention is to use them as a pipe assembly for conveying oil and/or gas and/or a liquid fossil energy carrier. For this purpose, it is advantageous to connect a plurality of pipe sections to form a pipe assembly, in particular two pipe sections, three pipe sections, four pipe sections, five pipe sections or more than five pipe sections.

With regard to the connection of the pipe sections, it is particularly advantageous to connect said pipe sections together in a materially bonded manner, which enables an extremely robust connection to be achieved, even against seismic events.

The materially bonded connection can be implemented in such a way that the pipe assembly has a continuous coating on the inside with corrosion-resistant and/or abrasive wear-protecting properties, in particular by means of a continuous combination of alternatingly arranged first and second coatings. Preferably, the first coatings of adjacent pipe sections are welded together in such a materially bonded manner that the region of the weld connection has no or only a slight material difference to the adjacent material of the first coatings.

It should be understood the advantages of a pipe section according to the first aspect of the invention, as described above, extend directly to a pipe assembly comprising a first pipe section and at least a second pipe section, each according to the first aspect of the invention.

It should be expressly noted that the subject matter of the second aspect can advantageously be combined with the subject matter of the preceding aspect of the invention, both individually or cumulatively in any combination.

According to a third aspect of the invention, the object is achieved by a method for manufacturing a pipe section according to the first aspect of the invention, characterized by the following steps:
providing a support layer consisting of a metal base material, wherein the support layer has a length, an inner diameter, an inner surface, an outer surface, at least two pipe section ends each having an end region and an intermediate region;
applying a first coating in each end region of the inner surface of the support layer, in particular using a laser deposition welding process; and
applying a second coating in the intermediate region of the inner surface of the support layer, in particular using an arc spraying process.

The above steps are to be understood as part of a method for manufacturing the pipe section. Depending on the embodiment, they can be supplemented by individual steps.

Before the first coating is applied, the support layer can be provided with a shoulder, in particular in the region of the inner surface where the first coating is to be applied in a designated manner.

The first coating can be applied with a varying first thickness, in particular depending on the circumferential angle of the pipe section. This can advantageously reduce the ovality of the pipe section, so that calibration of the pipe section end can be prevented or reduced in terms of the effort involved.

The first coating can be reworked after it has been applied, in particular using a machining process and/or a smoothing process.

When applying the second coating, it can also be applied at least partially overlapping the first coating in addition to the intermediate region.

After the second coating has been applied, the first coating and/or the second coating can be provide with a sealing.

After the first coating has been applied, the pipe section ends can be reworked. Preferably, the pipe section ends can be reworked to be flat using a machining method so that the pipe section ends have a completely flat surface. The pipe section can also be provided with a chamfer, in particular a chamfer on the outer edge of the pipe section and/or a chamfer on the inner edge of the pipe section. Furthermore or additionally, the pipe section ends can be reworked using a smoothing machining process.

The pipe section can be calibrated after the first coating has been applied so that the ovality of a pipe section end is within required tolerances after calibration.

It will be understood that the advantages of a pipe section according to the first aspect of the invention, as described above, extend directly to a method for manufacturing a pipe section according to the first aspect of the invention.

It is particularly expedient to roughen the support layer on the inner surface before applying the first coating and/or the second coating.

The support layer can be roughened in advance, at least in the region of the inner surface which is later to be coated with the second coating. Here, a blasting medium can be used which is brought into contact with the corresponding region of the inner surface with an average grain size and a blasting pressure predetermined within certain limits. The blasting medium may comprise blasting grit and/or corundum and/or precious corundum and/or zirconium corundum and/or flint and/or quartz and/or garnet and/or diamond and/or silicon carbide and/or chromium oxide and/or boron nitride.

By roughening the inner surface, the adhesion between the support layer and the second coating can be improved.

Optionally, the support layer on the inner surface is preheated to a temperature of greater than or equal to 20° C., preferably to a temperature of greater than or equal to 40° C., and more preferably to a temperature of greater than or equal to 70° C., before applying the first coating and/or the second coating.

Furthermore optionally, the support layer on the inner surface is preheated to a temperature of greater than or equal to 50° C., preferably to a temperature of greater than or equal to 60° C., and more preferably to a temperature of greater than or equal to 80° C., before applying the first coating and/or the second coating.

Such preheating causes the support layer to outgas before the second coating is applied, which improves the adhesion of the second coating to the support layer and enables a flawless surface of the second coating to be achieved.

It should be expressly noted that the subject matter of the third aspect can advantageously be combined with the subject matter of the preceding aspects of the invention, both individually or cumulatively in any combination.

More preferably, a second thickness of the second coating is applied in a varying manner depending on a circumferential angle of the pipe section and/or a longitudinal extension of the pipe section, in particular with a variance of greater than or equal to 3% relative to the maximum second thickness, preferably with a variance of greater than or equal to 5% relative to the maximum second thickness, and more preferably with a variance of greater than or equal to 10% relative to the maximum second thickness.

In other words, it is proposed here to vary the second thickness of the second coating in regions, in particular depending on the circumferential angle and/or the longitudinal extension of the second coating.

This allows the second coating to be adapted particularly advantageously to the expected use conditions of the pipe section. Thus, the second thickness of the second coating can be adapted to local corrosion conditions and/or local abrasion conditions.

This aspect also extends analogously to the first thickness of the first coating, which can be applied in a varying manner depending on the circumferential angle and/or the longitudinal extension of the first coating.

This allows a pipe section to be adapted to the expected use conditions as required, saving material and costs for the first coating and/or the second coating, in particular when compared to metallurgically clad pipes or hydromechanically clad pipes.

According to a further aspect of the invention, the object is achieved by a pipe section manufactured using a method according to the third aspect of the invention.

It should be understood that the advantages of a method according to the third aspect of the invention, as described above, extend directly to a pipe section manufactured by a method according to the third aspect of the invention.

According to a fourth aspect of the invention, the object is achieved by a method for manufacturing a pipe assembly from at least two pipe sections according to the second aspect of the invention, wherein a first pipe section and a second pipe section are connected to one another at two corresponding pipe section ends in a materially bonded manner.

It should be understood that the advantages of a pipe assembly according to the second aspect of the invention, as described above, extend directly to a method for manufacturing a pipe assembly according to the second aspect of the invention.

It should be expressly noted that the subject matter of the fourth aspect can advantageously be combined with the subject matter of the preceding aspects of the invention, both individually or cumulatively in any combination.

According to a fifth aspect of the invention, the object is achieved by using a pipe assembly according to the second aspect of the invention for conveying an oil-containing and/or gas-containing fluid and/or a fluid comprising a liquid fossil energy carrier.

It should be understood that the advantages of a pipe assembly according to the second aspect of the invention, as described above, extend directly to a use of a pipe assembly according to the second aspect of the invention.

It should be expressly noted that the subject matter of the fifth aspect can advantageously be combined with the subject matter of the preceding aspects of the invention, both individually or cumulatively in any combination.

Further advantages, details, and features of the invention can be found below in the described embodiments. In the figures, in detail:

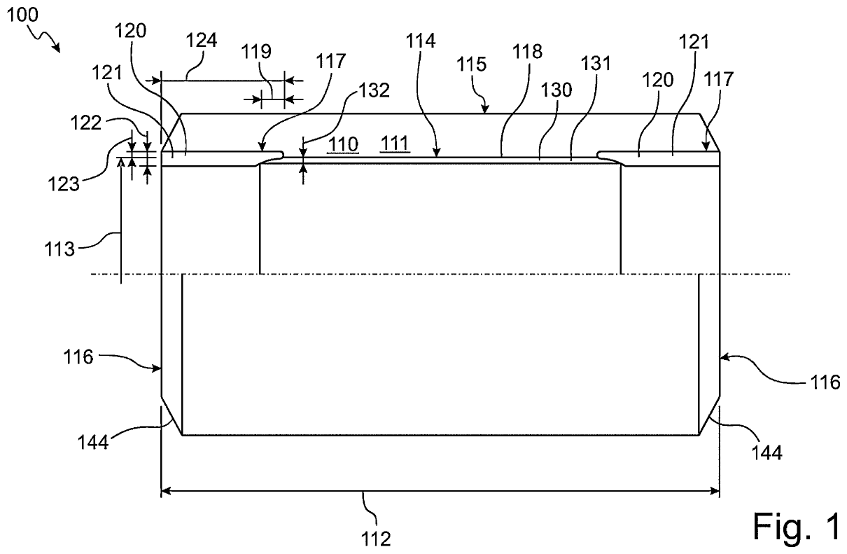

FIG. 1: schematically shows a first embodiment of a pipe section, wherein the pipe section is shown in a half section; and

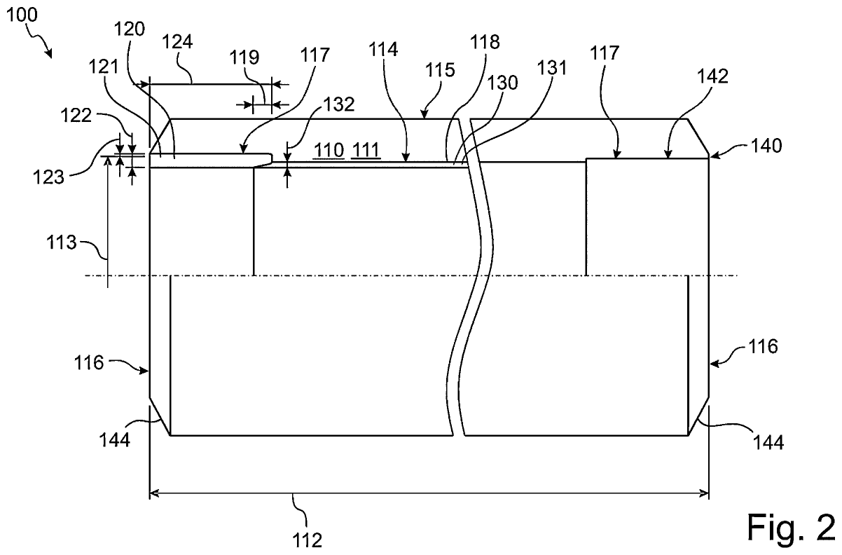

FIG. 2: schematically shows a second embodiment of a pipe section, wherein the pipe section is shown in a half section, and wherein only the support layer is shown to the right of the break line.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

The first embodiment of a pipe section 100 in FIG. 1, in particular a pipe section 100 for conveying oil and/or gas, substantially consists of:
a support layer 110 of a metal base material 111, wherein the support layer 110 has a length 112, an inner diameter 113, an inner surface 114, an outer surface 115, at least two pipe section ends 116 each having an end region 117 and an intermediate region 118;
a first coating 120 of a first metal coating material 121 in each end region 117 of the inner surface 114 of the support layer 110, wherein the first coating 120 is welded to the support layer 110, wherein the first coating 120 has a first thickness 122, a penetration depth 123 and a longitudinal extension 124; and
a second coating 130 consisting of a second metal coating material 131 in the intermediate region 118 of the inner surface 114 of the support layer 110, wherein the second coating 130 is sprayed onto the support layer 110 using a thermal spraying process.

The second coating 130 has a second thickness 132 of less than or equal to 2500 μm, preferably a second thickness 132 of less than or equal to 750 μm, and more preferably a second thickness 132 of less than or equal to 500 μm.

Advantageously, the second coating 130 may have a second thickness 132 of greater than or equal to 100 μm, preferably a second thickness 132 of greater than or equal to 200 μm, and more preferably a second thickness 132 of greater than or equal to 400 μm.

The first coating 120 may be applied to the support layer 110 using a deposition welding process, in particular using a laser deposition welding process. For the first coating 120, this can result in a penetration depth 123 of less than or equal to 500 μm, preferably a penetration depth 123 of less than or equal to 150 μm, and more preferably a penetration depth 123 of less than or equal to 75 μm.

The first coating 120 may have a first thickness 122 of less than or equal to 2500 μm, preferably a first thickness 122 of less than or equal to 1000 μm, and more preferably a first thickness 122 of less than or equal to 600 μm.

The first coating 120 may have a longitudinal extension 124 of greater than or equal to 30 mm, preferably a longitudinal extension 124 of greater than or equal to 50 mm, and more preferably a longitudinal extension 124 of greater than or equal to 65 mm.

The first coating 120 and/or the second coating 130 may have a sealing.

The pipe section 100 may have a chamfer 144.

The second embodiment of a pipe section 100 in FIG. 2 is similar to the first embodiment in FIG. 1, wherein the support layer 110 additionally has a shoulder 142. In this way, it can be advantageously achieved that the first coating 120 and the second coating 130, despite different first thickness 122 and second thickness 132, have a largely straight course of the inner surface (not designated) of the pipe section 100 in the region of the transition (not designated) and/or the overlap 119 from the first coating 120 to the second coating 130.

### LIST OF REFERENCE SIGNS

100 pipe section
110 support layer
111 base material
112 length
113 inner diameter
114 inner surface
115 outer surface
116 pipe section end
117 end region
118 intermediate region
119 overlap
120 first coating
121 first coating material
122 first thickness
123 penetration depth
124 longitudinal extension
130 second coating
131 second coating material
132 second thickness
140 inner edge
142 shoulder
144 chamfer

1.-27. (canceled)

28. A pipe section for conveying oil and/or gas, the pipe section comprising:
a support layer consisting of a metal base material, the support layer having:
a length,
an inner diameter,
an inner surface,
an outer surface, and
at least two pipe section ends each having an end region and an intermediate region;
a first coating on each end region of the inner surface of the support layer, the first coating consisting of a first metal coating material, the first coating being welded to the support layer, and the first coating having a first thickness, a penetration depth, and a longitudinal extension; and
a second coating on the intermediate region of the inner surface of the support layer, the second coating consisting of a second metal coating material, and the second coating is sprayed onto the support layer using a thermal spraying process,
wherein the second coating has a second thickness of less than or equal to 2500 μm.

29. The pipe section according to claim 28, wherein the second thickness is greater than or equal to 100 μm.

30. The pipe section according to claim 28, wherein the support layer has a shoulder at an inner edge.

31. The pipe section according to claim 28, wherein the first coating is applied to the support layer using a laser deposition welding process.

32. The pipe section according to claim 31, wherein the first coating has a penetration depth of less than or equal to 500 μm.

33. The pipe section according to claim 28, wherein the first coating has a first thickness of less than or equal to 2500 μm.

34. The pipe section according to claim 28, wherein the first coating has a first thickness of greater than or equal to 500 μm.

35. The pipe section according to claim 28, wherein the first coating has a longitudinal extension of greater than or equal to 30 mm.

36. The pipe section according to claim 28, wherein the first coating has a first thickness varying with a circumferential angle of the pipe section.

37. The pipe section according to claim 28, wherein the second coating is sprayed onto the support layer using an arc spraying process.

38. The pipe section according to claim 28, wherein the first coating and/or the second coating has a nickel content of greater than or equal to 38 wt. %.

39. The pipe section according to claim 28, wherein the first coating and/or the second coating has a chromium content of greater than or equal to 12 wt. %.

40. The pipe section according to claim 28, wherein the first coating and/or the second coating has a molybdenum content of greater than or equal to 2 wt. %.

41. The pipe section according to claim 28, wherein the first coating and/or the second coating has a content of niobium in combination with tantalum of greater than or equal to 2 wt. %.

42. The pipe section according to claim 28, wherein the first coating and/or the second coating has a Vickers hardness, measured at 20° C., of greater than or equal to 150 HV.

43. The pipe section according to claim 28, wherein the first coating and/or the second coating has an elongation at break A, measured at 20° C., of greater than or equal to 25%.

44. The pipe section according to claim 28, wherein the first coating and/or the second coating has a yield strength R_{p0.2}, measured at 20° C., of greater than or equal to 280 N/mm².

45. The pipe section according to claim 28, wherein the first coating and/or the second coating has a tensile strength Rₘ, measured at 20° C., of greater than or equal to 650 N/mm².

46. The pipe section according to claim 28, wherein the first coating and/or the second coating has a sealing.

47. The pipe section according to claim 46, wherein the sealing is polymer-based.

48. A pipe assembly comprising at least two pipe sections according to claim 1, wherein a first pipe section and a second pipe section are connected to one another at two corresponding pipe section ends in a materially bonded manner.

49. A method for manufacturing a pipe section, the method comprising steps of:
providing a support layer consisting of a metal base material, the support layer having:
a length,
an inner diameter,
an inner surface,
an outer surface,
at least two pipe section ends each having an end region and an intermediate region;
applying a first coating in each end region of the inner surface of the support layer using a laser deposition welding process; and
applying a second coating in the intermediate region of the inner surface of the support layer using an arc spraying process.

50. The method according to claim 49, wherein the support layer is roughened on the inner surface before the first coating and/or the second coating is applied.

51. The method according to claim 49, wherein, before the first coating and/or the second coating is applied, the support layer on the inner surface is preheated to a temperature of greater than or equal to 20° C.

52. The method according to claim 49, wherein a second thickness of the second coating is applied in a varying manner depending on a circumferential angle of the pipe section and/or a longitudinal extension of the pipe section, with a variance of greater than or equal to 3% relative to the maximum second thickness.

53. A method for forming a pipe assembly from at least two pipe sections according to claim 49, wherein a first pipe section and a second pipe section are connected to one another at two corresponding pipe section ends in a materially bonded manner.

54. A use of a pipe assembly according to claim 53 for conveying an oil-containing and/or gas-containing fluid and/or a fluid comprising a liquid fossil energy carrier.
